(19) United States
(12) Patent Application Publication
(10) Pub. No.: US 2009/0185131 A1
(43) Pub. Date: Jul. 23, 2009

(54) METHOD AND SYSTEM FOR PROVIDING EYEWEAR WITH ADJUSTABLE COUNTERWEIGHT

(75) Inventor: Daniel Esbensen, Blue Diamond, NV (US)

Correspondence Address: QUINE INTELLECTUAL PROPERTY LAW GROUP, P.C., P O BOX 458, ALAMEDA, CA, 94501, US

(73) Assignee: Tough Technologies, Inc.

(21) Appl. No.: 12/355,748

(22) Filed: Jan. 16, 2009

Related U.S. Application Data
(60) Provisional application No. 61/021,627, filed on Jan. 16, 2008.

(51) Int. Cl. G02C 3/00

(52) U.S. Cl. 351/156

(57) ABSTRACT

Eyewear feature and around-the-head eyewear frame and a counter weight to reduce pressure on the nose and increase comfort.

### CROSS REFERENCE TO RELATED APPLICATIONS

This application claims priority from provisional patent application 61/021,627 filed 16 Jan. 2008 and incorporated herein by reference.

### PRECAUTIONARY REQUEST TO FILE AN INTERNATIONAL APPLICATION, DESIGNATION OF ALL STATES, AND STATEMENT THAT AT LEAST ONE APPLICANT IS A UNITED STATES RESIDENT OR ENTITY

Should this document be filed electronically or in paper according to any procedure indicating an international application, Applicant hereby requests the filing of an international application and designation of all states. For purposes of this international filing, all inventors listed on a cover page or any other document filed herewith are applicants for purposes of United States National Stage filing. For purposes of this international filing, any assignees listed on a cover page or any other document filed herewith are applicants for purposes of non-United States national stage filing, or, if no assignee is listed, all inventors listed are applicants for purposes of non-United States national stage filing. For purposes of any international filing, applicants state that at least one applicant is a United States resident or United States institution. Should this application be filed in as a national application in the United States, this paragraph shall be disregarded.

### FIELD OF THE INVENTION

The present invention relates to the field of more comfortable eyewear and eyeglass applications.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Important characteristics of eyeglasses include both the position with respect to the eye and overall comfort to the wearer. Many different designs have been employed, with varying success, to improve eyewear design.

One particular element that some designers have attempted to incorporate in eyewear design is use of some form of counter weight at the back or sides of the wearer's head so as to reduce the weight and irritation on the bridge of the wearers nose and also more evenly distribute the weight on the wearers ears.

The following U.S. patents each propose different designs that in some cases discuss using a counter weight with eyeglasses.

| | | Named | |
|---|---|---|---|
| U.S. Pat. No. | Issued | Inventor | Title |
| 0,182,013 | September, 1876 | Andross | |
| 1,026,272 | May, 1912 | Leveque | |
| 1,819,738 | August, 1931 | Daniels | Spectacles |
| 2,659,266 | November, 1953 | Swisher | Adjustable trial frame holder |
| 3,495,898 | February, 1970 | Del Vecchio | Makeup Eyeglasses |
| 3,840,294 | October, 1974 | Kneier | Makeup Glasses |
| 3,955,885 | May, 1976 | Aronsohn | Eyeglass support device |
| 4,006,974 | February, 1977 | Resnick | Eyeglass structure |
| 4,129,362 | December, 1978 | Lorenzo | Eyeglasses |
| 4,886,349 | December, 1989 | Willis | Temples-less eyeglass frame |
| 4,917,479 | April, 1990 | Bidgood | Adjustable counterweighted temple pieces |
| | | | for eyeglasses |
| 5,016,999 | May, 1991 | Williams | Discrete lens eyeglasses |
| 5,347,325 | September, 1994 | Lei | Adjustable temple for glasses |
| 5,506,638 | April, 1996 | Donner | Spectacles with weight bearing cheek rest |
| 5,666,182 | September, 1997 | Donner | Spectacles with weight bearing cheek rest |
| | | | using flexible frame attachment with a |
| | | | groove |
| 5,859,684 | January, 1999 | Rittmann | Eyeglass support system |
| 5,956,117 | September, 1999 | Suh et al. | Eyeglasses with head embracing temple |
| 6,142,623 | November, 2000 | Jones | Counterpoised cranial support for eyewear |
| 6,325,507 | December, 2001 | Jannard et al. | Eyewear retention system extending across |
| | | | the top of a wearer's head |
| 6,648,471 | November, 2003 | Dalrymple et al. | Eyeglass frame |
| 6,986,577 | January, 2006 | Jamie | Eyeglasses with extension member supports |

Recently, a design of eyewear has become available that features an around-the-head frame with a magnetic connector in the front, presented under the brand-name CliC™. This eyewear is promoted as having the advantage that it hangs easily around the neck when not in use and is described by its sellers as using a neodymium magnet at the bridge of the nose, wrapping around the neck.

This application is being filed with a non-patent literature submissions that are being provided as information disclosure. These documents, and all other documents filed herewith, are incorporated herein by reference.

### SUMMARY

The present invention is directed to a set of eyewear that uses a wrap-around design and one or more rear counter weights to facilitate optimally balanced eyewear for an individual user. In various embodiments, eyewear according to the invention has one or more openings allowing placement of one or more weights at the rear and/or sides of the eyewear to allow a user to achieve optimum balance. Using the wrap-around frames allows the eyewear to be balanced with an adjustable counterweight and without the awkwardness of many earlier counter-weight designs.

In further embodiments, the present invention is directed to a retro-fig or adaptor kit that can be either permanently or temporarily attached to any conventional eyewear to provide one or more rear counter weights to facilitate an optimally balanced eyeglass for an individual user. Such a retro-fit or adaptor kit may also use a magnet or fastener to connect at the back of the head to provide an openable wrap-around design.

In various embodiments, a retro-fit or adaptor kit according to the invention has one or more openings or attachment areas allowing placement of one or more weights at the rear and/or sides of eyewear to allow a user to achieve optimum balance. Using the kit allows existing eyewear to be balanced with an adjustable counterweight and without the awkwardness of many earlier counter-weight designs.

The invention and various specific aspects and embodiments will be better understood with reference to the following drawings and detailed descriptions. For purposes of clarity, this discussion refers to some specific example designs. However, the essential design of the invention can be embodied in products with a number of variations. It is therefore intended that the invention not be limited except as provided in the attached claims and equivalents.

Furthermore, it is well known in the art that consumer product eyeglasses such as described herein can include a variety of different components and additional decorative or other design elements and materials. It is also well known in the art that both the eyeglass pieces and the frames can be made in many shapes and sizes and from many different materials. Wrap-around counterweight eyeglass frames and/or a retrofit adaptor kit according to specific embodiments of the invention can be made from materials suitable for making other eye glasses frames, including, either alone or in combination, plastics, metals, alloys, ceramics, rubbers, plant-derived moldable polymers, etc.

Furthermore, as will be understood in the art, an eyepiece frame according to specific embodiments of the invention can be used to house any eyepiece or eyeglasses, including corrective lenses, sunglasses, costume lenses, magnifying lenses, jeweler's lenses, polarizing glasses, etc. Eyepieces of the invention can also include an electronic display device, such as a self-contained wearable visual display or virtual reality head set or glasses or a head set or glasses that are used to enhance observation of a visual display, such as electronic lenses allowing for 3-D or other enhanced viewing, night vision viewing, infra-red viewing, etc. Eyepieces according to specific embodiments of the invention, whether electronic or conventional, can include a single viewing area one-piece lens or display, such as is common for safety-goggles and is known for some types of sunglasses and/or electronic or virtual reality display, or can include two-piece displays, such as conventional glasses. The common elements to all these various types of head-wear or eye-wear is that the weight is generally carried on the bridge of the nose, with some amount carried over the ears. Using the devices and methods of the present invention, any such type of head-wear or eye-wear can include a counter-weight to relieve the weight carried by the bridge of the nose.

All references, publications, patents, and patent applications cited herein are hereby incorporated by reference in their entirety for all purposes.

### BRIEF DESCRIPTION OF THE DRAWINGS

FIG. 1 illustrates eyewear according to specific embodiments of the invention that show a closed clasp at the front and a counter-weight area at the rear.

FIG. 2 and FIG. 2A illustrate example eyewear according to the invention that show the clasp at the front open and a close-up of a counter-weight area at the rear with mechanisms for adding weights.

FIG. 3 illustrates eyewear eyewear of FIG. 1 on a wearer.

FIG. 4 illustrates an example eyewear according to specific embodiments of the invention that show a closed clasp at the rear and two counter-weight areas at the rear on either side.

FIG. 5 and FIG. 5A illustrate example eyewear according to the invention that show the clasp at the rear and a close-up of a counter-weight area at the rear with mechanisms for adding weights.

FIG. 6 illustrates an example eyewear according to specific embodiments of the invention shown as worn on a human head with a closed clasp at the rear and two counter-weight areas at the rear on either side.

FIG. 7 illustrates an example of a retrofit kit that can be used to provide a counterweight on conventional eyewear according to specific embodiments of the invention.

FIG. 8 illustrates a side view of an example eyewear counterweight retrofit kit that can be used to provide a counterweight on conventional eyeglasses according to specific embodiments of the invention.

FIG. 9 illustrates a side view of an example eyewear counterweight retrofit kit as worn on a human head according to specific embodiments of the invention The low position of the counterweight at the base of the head is an optional embodiment for both the retrofit kit and eyewear with integrated counterweights.

FIG. 10 illustrates a top view of an example eyewear counterweight retrofit kit (two pieces) placed roughly as attached to conventional sunglasses according to specific embodiments of the invention.

FIG. 11 illustrates a top view of an example eyewear counterweight retrofit kit (two pieces) as attached to conventional sunglasses and connected together at the rear according to specific embodiments of the invention. In this figure, the two thickened portions at the rear serve to hold counterweight mechanisms and attachment mechanisms (e.g., magnets) as discussed herein.

FIG. 12 illustrates an example eyewear counterweight retrofit kit shown as separate left and right pieces or arms, with a receiving portion for attaching to eyewear frames either by friction or by gluing and showing separated adjustable weight portions and attachment portions.

FIG. 13 illustrates attachment of an example eyewear counterweight retrofit kit (right side) with a receiving portion glued to eyewear frames according to specific embodiments of the invention.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

### DETAILED DESCRIPTION

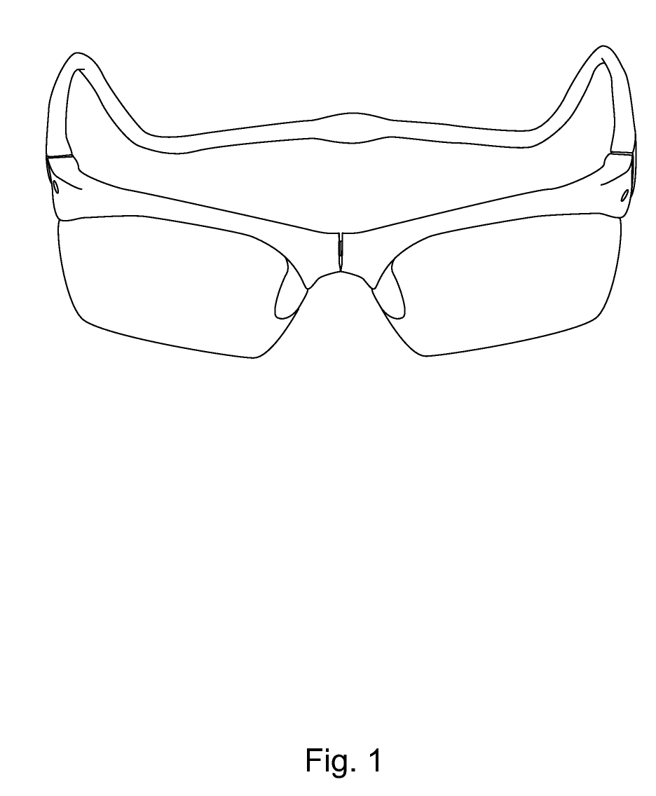

FIG. 1 illustrates eyewear according to specific embodiments of the invention that show a closed clasp at the front and a counter-weight area at the rear. This figure illustrates a general embodiment. In this figure, the counter weight mechanism is illustrated as including a visibly enlarged portion at the rear of the eyeglass frames. This is shown for the purpose of illustration and this portion may not be visibly enlarged in all embodiments.

In a general embodiment, the invention comprises around-the-head eyewear with a counter-weight in the rear designed to remove weight from the bridge of the nose and/or to redistribute weight at the ears.

In an alternative embodiment, the invention comprises around-the-head eyewear with an adjustable counter-weight in the rear that allows wearers to adjust the counterweight to redistribute weight as they desire.

In an alternative embodiment, the invention comprises around-the-head eyewear with a counter-weight in the rear and with a magnetic and/or mechanical snap connection at the front of the eyewear.

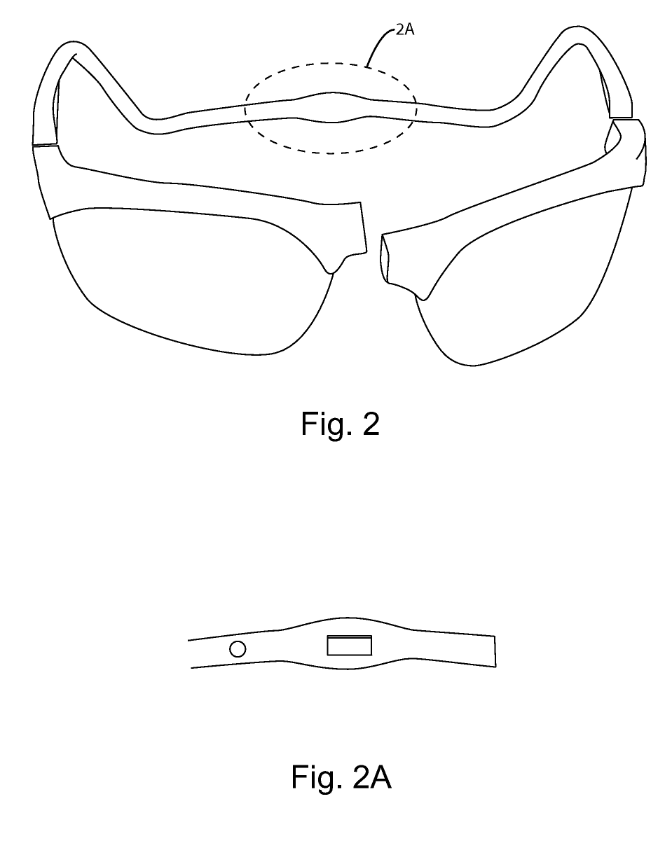

FIG. 2 and FIG. 2A illustrate example eyewear according to the invention that show the clasp at the front open and a close-up of a counter-weight area at the rear Front clasp 10 can include a magnet as is used in the CliC™ glasses described above.

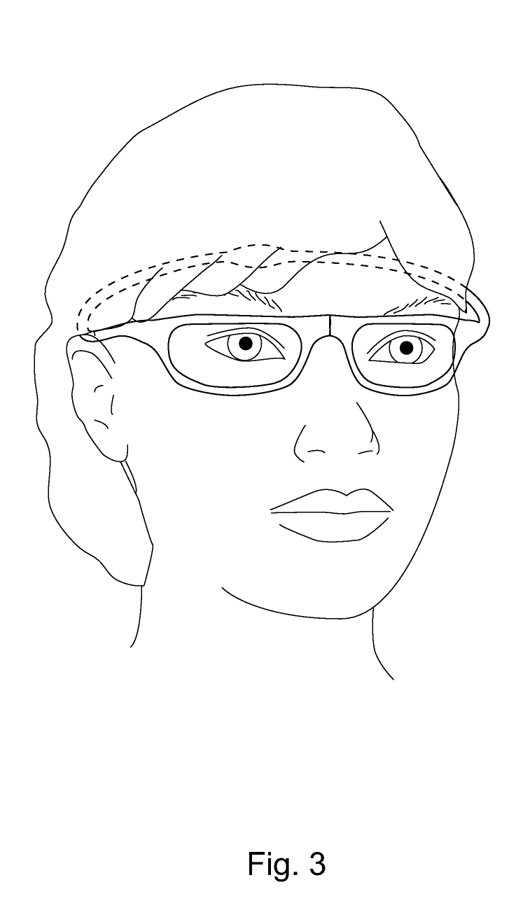

FIG. 3 illustrates eyewear eyewear of FIG. 1 on a wearer.

In an alternative embodiment, the invention comprises around-the-head eyewear with a counter-weight in the rear and with a snap connection at the rear of the eyewear.

### Counterweight Mechanism

Various designs can be employed according to specific embodiments of the invention to provide either a fixed or adjustable counter-weight. For a fixed counter-weight, the rear portion of the around-the-head frames can be fabricated from a material that by its volume and density provides the desired counter-weighting factor. This may be accomplished by making a portion of the rear frame thicker (as shown) or by incorporating a weighing material into a rear portion of the frames.

To make the counter-weight adjustable, a means for receiving and holding a weighing material into the rear portion of the glasses is employed. This can include a opening or indentation in the rear portion of the frame for receiving and holding weighted beads or rods or other materials. The opening can be one that is plugged by a cap or lid after the weighted material is introduced. Alternatively, the weighted material may snap into openings at the rear of the glasses and held in place by friction.

FIG. 4 illustrates an example eyewear according to specific embodiments of the invention that show a closed clasp at the rear and two counter-weight areas at the rear on either side.

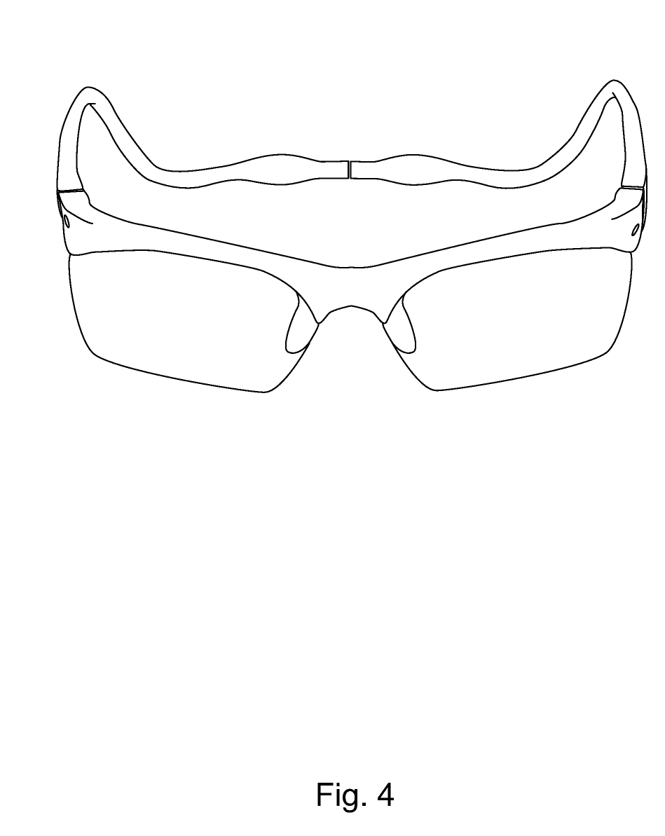

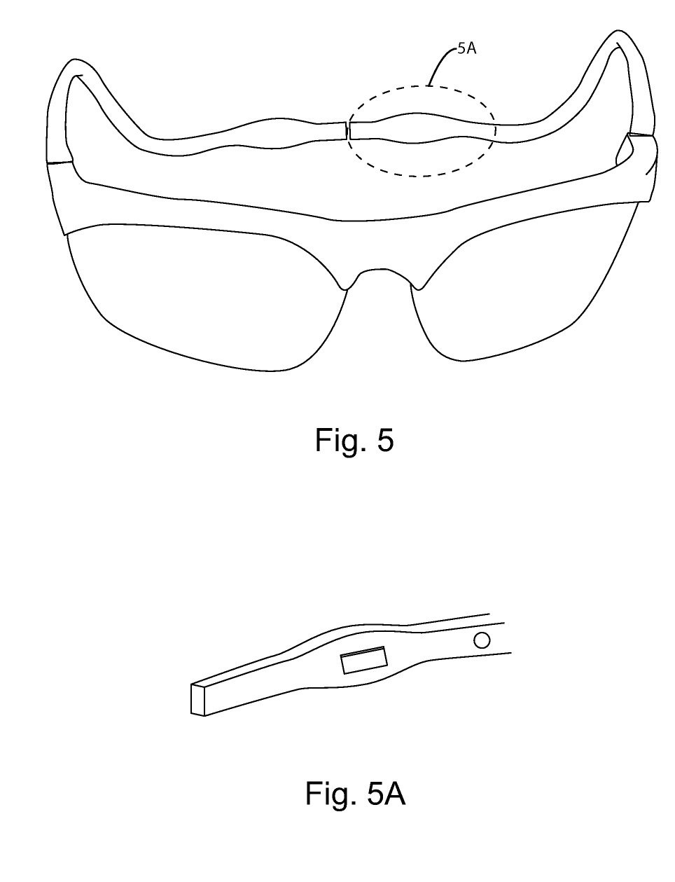

FIG. 5 and FIG. 5A illustrate example eyewear according to the invention that show the clasp at the rear and a close-up of a counter-weight area at the rear with mechanisms for adding weights.

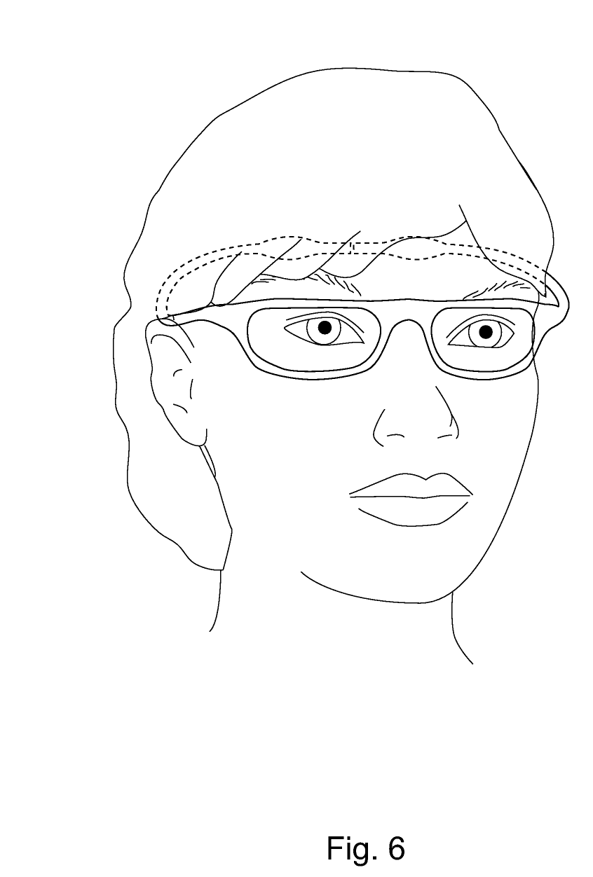

FIG. 6 illustrates an example eyewear according to specific embodiments of the invention shown as worn on a human head with a closed clasp at the rear and two counter-weight areas at the rear on either side.

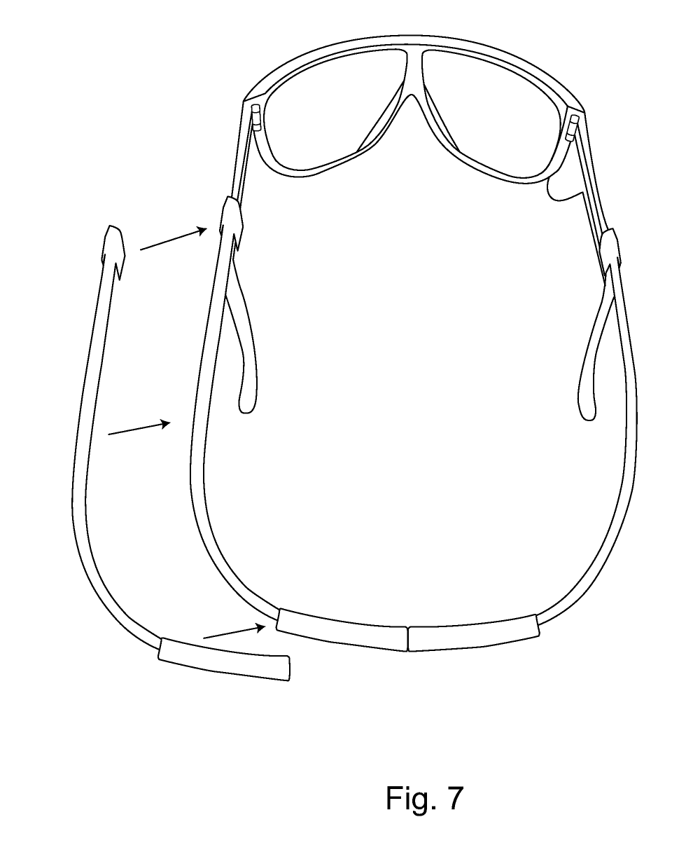

FIG. 7 illustrates an example of a retrofit kit that can be used to provide a counterweight on conventional eyewear according to specific embodiments of the invention.

FIG. 8 illustrates a side view of an example eyewear counterweight retrofit kit that can be used to provide a counterweight on conventional eyeglasses according to specific embodiments of the invention.

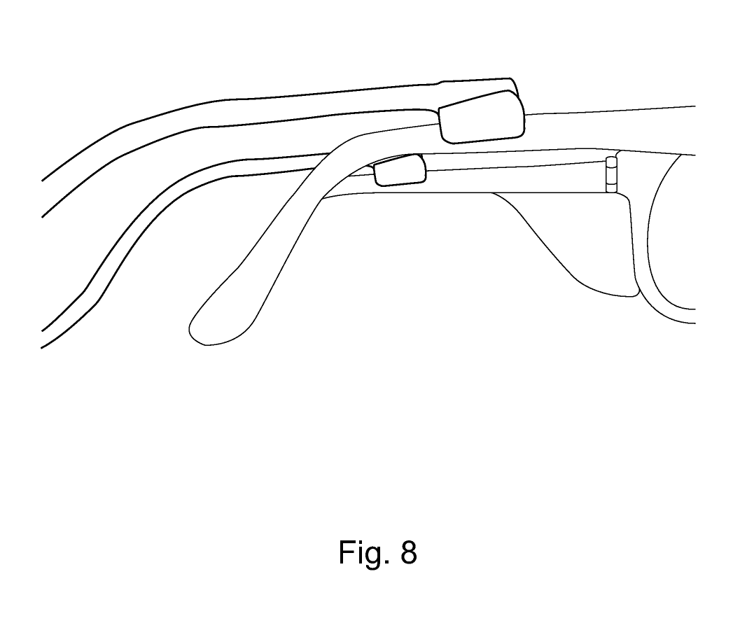

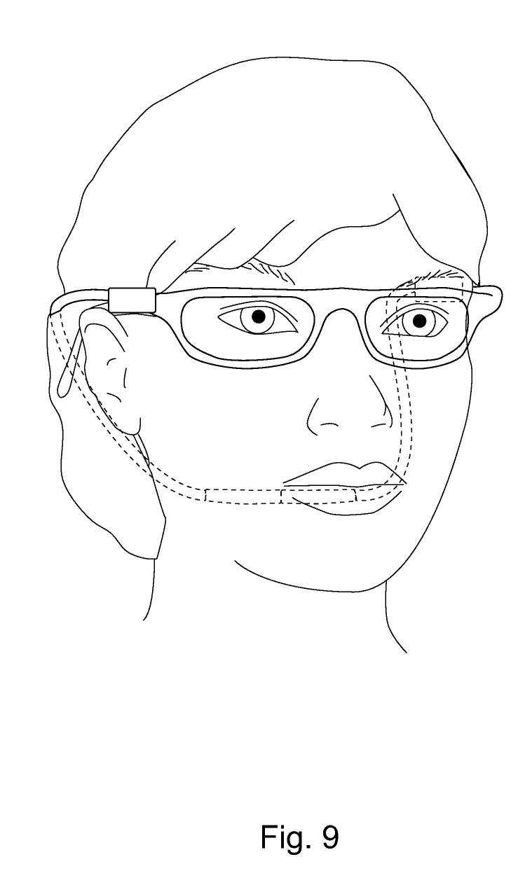

FIG. 9 illustrates a side view of an example eyewear counterweight retrofit kit as worn on a human head according to specific embodiments of the invention The low position of the counterweight at the base of the head is an optional embodiment for both the retrofit kit and eyewear with integrated counterweights.

FIG. 10 illustrates a top view of an example eyewear counterweight retrofit kit (two pieces) placed roughly as attached to conventional sunglasses according to specific embodiments of the invention.

FIG. 11 illustrates a top view of an example eyewear counterweight retrofit kit (two pieces) as attached to conventional sunglasses and connected together at the rear according to specific embodiments of the invention. In this figure, the two thickened portions at the rear serve to hold counterweight mechanisms and attachment mechanisms (e.g., magnets) as discussed herein.

FIG. 12 illustrates an example eyewear counterweight retrofit kit shown as separate left and right pieces or arms, with a receiving portion for attaching to eyewear frames either by friction or by gluing and showing separated adjustable weight portions and attachment portions.

FIG. 13 illustrates attachment of an example eyewear counterweight retrofit kit (right side) with a receiving portion glued to eyewear frames according to specific embodiments of the invention.

The invention has now been described with reference to specific embodiments. Other embodiments will be apparent to those of skill in the art. In particular, while an example pair of eyewear has been illustrated, the invention can be embodied in a wide variety of different eyewear designs. It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

What is claimed:

1. Eyewear able to be adjusted to remove weight from the nose comprising:
an around the head functionally rigid frame;
a counter-weight located at the rear of the frame.

2. The Eyewear of claim 1 further comprising:
a magnetic fastening clasp at the front of the frames, between the lens.

3. The Eyewear of claim 1 further comprising:
a snap or friction fastening clasp at the front of the frames, between the lens.

4. The Eyewear of claim 1 further comprising:
a Velcro fastening clasp at the front of the frames, between the lens.

5. The Eyewear of claim 1 further comprising:
a fastening clasp at the rear of the frames;
at least two counter weights, one on each side of the clasp.

6. The Eyewear of claim 1 further comprising:
a fastening clasp at the rear of the frames;
at least one adjustable counter weight mechanism.

7. The Eyewear of claim 1 further comprising:
a fastening clasp at the rear of the frames;
a counterweight incorporated into said fastening clasp.

8. The Eyewear of claims 4 to 7 wherein said fastening clasp comprises a magnetic clasp.

9. The Eyewear of claims 4 to 7 wherein said fastening clasp comprises a snap clasp.

10. The Eyewear of claims 4 to 7 wherein said fastening clasp comprises a Velcro clasp.

11. The Eyewear of claims 1 to 7 wherein said counter-weight is fixed during manufacture.

12. The Eyewear of claims 1 to 7 wherein said counter-weight is adjustable by a user by adding or removing weight elements.

13. The Eyewear of claims 1 to 7 wherein said counter-weight is adjustable by a user by moving weight elements further towards the rear of the glasses to create a greater levered weight effect.

14. The Eyewear of claims 1 to 7 wherein said counter-weight is adjustable by a user by moving weight elements further towards the rear of the glasses to create a greater levered weight effect.

15. An eyewear adaptor kit able to be adjusted to remove weight from the nose comprising:
a rear portion of an around the head functionally rigid frame, said rear portion attachable to conventional eyewear frames;
a counter-weight located at the rear of the frame.

16. The Eyewear of claim 15 further comprising:
a rear portion of an around the head functionally rigid frame in two pieces, each piece comprising:
a clip end for attaching to one side of an eyewear frame; and
a fastening clasp end for attaching to another of said two pieces.

17. The Eyewear of claim 16 further wherein:
said fastening end is a friction fastening end.

18. The Eyewear of claim 16 further wherein:
said fastening end is a Velcro fastening end.

19. The Eyewear of claim 15 further comprising:
a fastening clasp at the rear of the frames;
at least two counter weights, one on each side of the clasp.

20. The Eyewear of claim 15 further comprising:
a fastening clasp at the rear of the frames;
at least one adjustable counter weight mechanism.

21. The Eyewear of claim 15 further comprising:
a fastening clasp at the rear of the frames;
a counterweight incorporated into said fastening clasp.

22. The Eyewear of claims 15 to 21 wherein said fastening clasp comprises a magnetic clasp.

23. The Eyewear of claims 15 to 21 wherein said fastening clasp comprises a snap clasp.

24. The Eyewear of claims 15 to 21 wherein said fastening clasp comprises a Velcro clasp.

25. The Eyewear of claims 15 to 21 wherein said counter-weight is fixed during manufacture.

26. The Eyewear of claims 15 to 21 wherein said counter-weight is adjustable by a user by adding or removing weight elements.

27. The Eyewear of claims 15 to 21 wherein said counter-weight is adjustable by a user by moving weight elements further towards the rear of the glasses to create a greater levered weight effect.

28. The Eyewear of claims 15 to 21 wherein said counter-weight is adjustable by a user by moving weight elements further towards the rear of the glasses to create a greater levered weight effect.
